(19) United States
(12) Patent Application Publication
(10) Pub. No.: US 2013/0229733 A1
(43) Pub. Date: Sep. 5, 2013

(54) Lightening Protection Apparatus Using TN-C Common Ground

(71) Applicants: Jae Wook Woo, Gangnam-gu (KR); Yong Joon Shu, Yeonsu-gu (KR); Jae Hyung Woo, Bupyeong-gu (KR); Dall Pyo Hong, Eumseong-gun (KR); Kook Young Kim, Gwangju-si (KR); Jeong Bin Kim, Hwaseong-si (KR); Gui Jung Kim, Seobuk-gu (KR); Jae Won Han, Suji-gu (KR); Seong Hyerk Suh, Gwangju-si (KR)

(72) Inventors: Jae Wook Woo, Gangnam-gu (KR); Yong Joon Shu, Yeonsu-gu (KR); Jae Hyung Woo, Bupyeong-gu (KR); Dall Pyo Hong, Eumseong-gun (KR); Kook Young Kim, Gwangju-si (KR); Jeong Bin Kim, Hwaseong-si (KR); Gui Jung Kim, Seobuk-gu (KR); Jae Won Han, Suji-gu (KR); Seong Hyerk Suh, Gwangju-si (KR)

(73) Assignee: Ground Co., Ltd., Gyeonggi-do (KR)

(21) Appl. No.: 13/884,410

(22) PCT Filed: Sep. 22, 2011
(86) PCT No.: PCT/KR11/06997

§ 371 Date: May 9, 2013

(30) Foreign Application Priority Data
Nov. 18, 2010 (KR) 10-2010-0115147

(51) Int. Cl. H01F 27/34

(52) U.S. Cl. CPC H01F 27/343
USPC 361/40

(57) ABSTRACT

The present invention relates to a lightning protection apparatus using a TN-C common ground. A lightning protection apparatus using a TN-C common ground according to the present invention, which is disposed between a power source part and load facilities and is connected in series thereto in order to protect the power source part and the load facilities from lightning, includes: an input part surge protection circuit connecting to the power source part; an output part surge protection circuit connecting to the load facilities; a double winding transformer having a primary part and a secondary part, which connect to the input part surge protection circuit and the output part surge protection circuit, respectively; and common ground members connecting, respectively, to the input part surge protection circuit, the double winding transformer, the output part surge protection circuit, and the load facilities such that electric potentials applied to all of the former are the same as a reference electric potential. According to the present invention, malfunctioning of electromagnetic facilities can be prevented against overcurrent, grounding, electric leakage, and momentary short circuiting of the power source part or load facilities due to a lightning surge, to thereby save manpower. In addition, electric and electronic communication/information facilities, signal facilities, and control facilities can be efficiently operated without damage due to a lightning surge, to thereby improve economic efficiency.

### TECHNICAL FIELD

The present invention relates to a lightning protection apparatus, and more particularly, to a lightning protection apparatus using a Terra Neutral-Combined (TN-C) common grounding system, which applies a double winding transformer circuit for replacing a Terra-Terra (TT) grounding system employing a delta connection with a TN-C common system employing a Y-connection to provide the same electric potential as that of common grounding, and which protects a load circuit with surge protection circuits provided at both input and output ends thereof so as to shield input and output of the double winding transformer while interrupting and removing a lightning surge.

### BACKGROUND ART

In general, a delta (A) connection power supply employs an isolated grounding system and a Y-connection power supply employs a common grounding system, and about ten countries, such as Japan, Somalia, Guatemala, Honduras, North Korea, the Philippines, and the like, employ an isolated grounding system, and most other countries employ a common grounding system. In Korea, although there has been much confusion due to mixed use of the isolated grounding system of Japan and a conventional Y-connection power supply system, a common grounding system according to international technical standards is newly adopted through revision of KSC-IEC in 2005. However, since many existing facilities still employ a delta connection type power supply system, the isolated grounding system vulnerable to lightning surges and other surges is still used in many facilities. Thus, an apparatus for changing a delta connection power supply system into a Y-connection power supply system and a common grounding system in a simple and economically feasible manner is required in the art. Although a surge protector can be provided to a secondary side of a power interrupter as a measure for preventing a lightning surge, a primary side of a lightning protecting isolation transformer can be damaged or magnetic induction can be induced to a secondary side of the isolation transformer if a strong lightning surge is applied, causing failure in interruption of lightning. In particular, the isolation transformer cannot function against the induced lightning and surge through the earth or ground as well as an electric power wire. Moreover, since voltage of the lightning surge is very high, the isolation transformer or a surge protection device (SPD) cannot function against the lightning surge if insulation destruction occurs in a load facility or an electric power line.

FIG. 1 is a schematic diagram of a system in which load facilities are installed in a delta connection power supply system and an isolation transformer.

Referring to FIG. 1, a delta connection power supply system in the related art includes a power source 1 and a delta connection circuit 31, and a lightning protecting insulation transformer 33 and load facilities 4 are connected to the power supply system. The delta connection circuit 31, the isolation transformer 33, and the load facilities 4 employ isolated grounding systems, respectively. In the isolated grounding system, difference in electric potential can be generated between the power source 1, the delta connection circuit 31, the isolation transformer 33, and the load facilities 4. However, when an electric potential difference is generated, lightning surges and other surges can be introduced, thereby causing damage or malfunction of the load facilities 4. In this regard, the isolation transformer 33 also fails to solve the problem of malfunction or damage to the load facilities 4, such as electric/electronic facilities, information/communication facilities, and control/measurement facilities, since the isolation transformer 33 cannot shield a primary side voltage due to isolation breakdown or electromagnetic induction of a high surge voltage from the primary side of the isolation transformer 33 to the secondary side thereof so that most of the primary side voltage is induced to the secondary side without being shielded.

### DISCLOSURE

[Technical Problem]

An aspect of the present invention is to provide a lightning protection apparatus using a TN-C common ground, which is disposed between a power supply and load facilities and connected in series thereto to protect the power supply and the load facilities from lightning and to guarantee stable operation thereof by removing an uninterrupted lightning surge while dampening and interrupting abnormal voltage.

Another aspect of the present invention is to provide a lightning protection apparatus using a TN-C common ground, which includes a double winding transformer and a surge protection circuit arranged such that a neutral line of the double winding transformer, the ground of load facilities, and a reference ground of the surge protection circuit have the same electric potential, thereby preventing damage or malfunction of the load facilities due to a difference between electric potentials when residual abnormal voltage is present.

[Technical Solution]

In accordance with one aspect of the present invention, there is provided a lightning protection apparatus disposed between a power supply and load facilities and connected in series thereto to protect the power supply and the load facilities from lightning, which includes: an input part surge protection circuit connected to the power supply; an output part surge protection circuit connected to the load facilities; a double winding transformer having a primary part and a secondary part connected to the input part surge protection circuit and the output part surge protection circuit, respectively; and a common grounding unit connected to the input part of the surge protection circuit, the double winding transformer, the output part surge protection circuit, and the load facilities such that all electric potentials applied thereto are the same as a reference electric potential.

The double winding transformer may include a Y-connection having a neutral line, each of the input part surge protection circuit and the output part surge protection circuit may include an electrostatic device, and the neutral line and the electrostatic devices may be connected to the common grounding unit.

The input part surge protection circuit may include a first switch for interrupting a connection with the power supply, and the output part surge protection circuit may include a second switch for interrupting connections with the load facilities.

The electrostatic device of the input part surge protection circuit may be connected to the power supply through the first switch, and the electrostatic device of the output part surge protection circuit may be connected to the load facilities through the second switch.

The power supply may include a power source and a delta connection power source circuit.

[Advantageous Effects]

According to the present invention, the lightning protection apparatus prevents malfunction of electromagnetic facilities upon overcurrent, grounding, electric leakage, and momentary short circuit of the power supply or the load facilities due to a lightning surge, thereby saving manpower, and enabling efficient operation of electric/electronic communication/information facilities, signal facilities, and control facilities without damage due to a lightning surge, thereby improving economic feasibility.

### DESCRIPTION OF DRAWINGS

FIG. 1 is a schematic diagram of a system in which load facilities are connected to a delta connection power supply system and an isolation transformer.

FIG. 2 is a schematic diagram showing a basic configuration of a lightning protection apparatus in which a TN-C common ground is disposed between a power supply and load facilities according to the present invention.

FIG. 3 is a circuit diagram showing a configuration of a lightning protection apparatus applied to a single-phase two-line power supply system, according to a first embodiment of the present invention.

FIG. 4 is a circuit diagram showing a configuration of a lightning protection apparatus applied to a three-phase three-line power supply system, according to a second embodiment of the present invention.

FIG. 5 is a schematic diagram of a facility for testing lightning surge voltage interruption performance of the isolation transformer of FIG. 1.

FIG. 6 is a schematic diagram of a facility for testing lightning surge voltage interruption performance of the lightning protection apparatus of FIG. 2.

FIG. 7 is a schematic diagram of a facility for testing lightning surge current discharge performance of the isolation transformer of FIG. 1.

FIG. 8 is a schematic diagram of a facility for testing lightning surge current discharge performance of the lightning protection apparatus of FIG. 2.

FIG. 9 is a table depicting a test result of the facilities of FIGS. 5 to 8.

### BEST MODE

Hereinafter, exemplary embodiments of the present invention will be described in detail with reference to the accompanying drawings. However, it should be understood that the present invention is not limited to specific embodiments and includes all modifications, equivalents, and replacements without departing from the spirit and scope of the present invention.

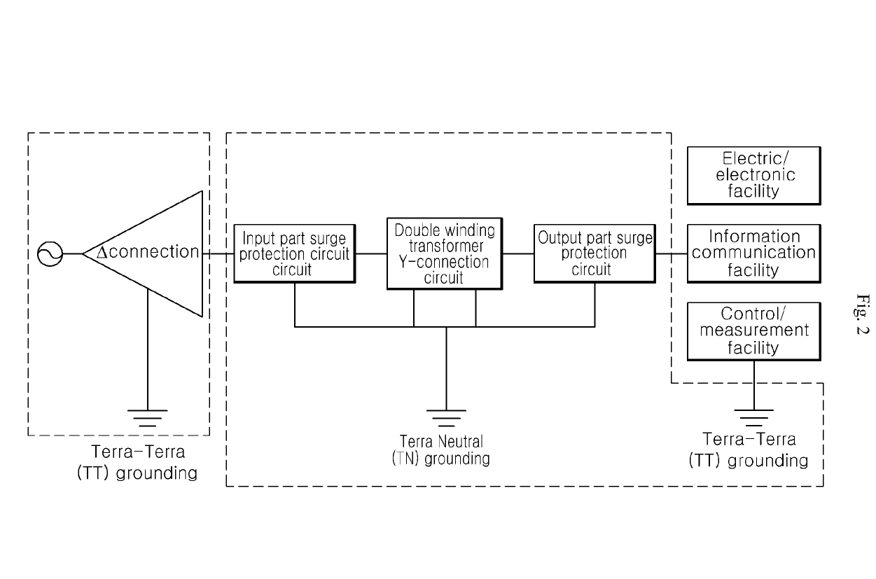

FIG. 2 is a schematic diagram showing a basic configuration of a lightning protection apparatus in which a TN-C common ground is disposed between a power supply and load facilities according to the present invention. Referring to FIG. 2, the lightning protection apparatus 150 of the present invention are disposed between a power supply 35, which includes a power source 1 and a delta connection power supply system 31 responsible for distribution of electric power, and load facilities 4, and are connected in series thereto. The lightning protection apparatus 150 generally includes an input part surge protection circuit 2, an output part surge protection circuit 3, and a double winding transformer between the input part surge protection circuit 2 and the output part surge protection circuit 3, and serves to prevent a lightning surge from being transferred to the load facilities by shielding a connection between the input part surge protection circuit 2 and the output part surge protection circuit 3, as described below. The double winding transformer 30 employs a Y-connection and has a neutral line to construct a TN-C type common grounding system using a common connection such that a neutral point of the double winding transformer 30, grounds of the load facilities 4, and reference grounds of the input and output part surge protection circuits 2, 3 have the same electric potential when residual abnormal voltage is generated or when the electric potentials of the load facilities 4 and the input and output part surge protection circuits 2, 3 differ from the electric potential of the neutral line of the double winding transformer 30. As used herein, the term TN-C type grounding refers to a grounding system in which a power supply is grounded and an intermediate neutral line is coupled to load facilities to be protected such that the load facilities can be grounded. In summary, as described above, the lightning protection apparatus according to the present invention is provided with a multiple bidirectional surge protection circuit and a common grounding system at an input part and an output part of the double winding transformer 30. In FIG. 2, the power supply 35 includes the power source 1 and the delta connection circuit 31, which may be suitably selected according to the kind of power source 1.

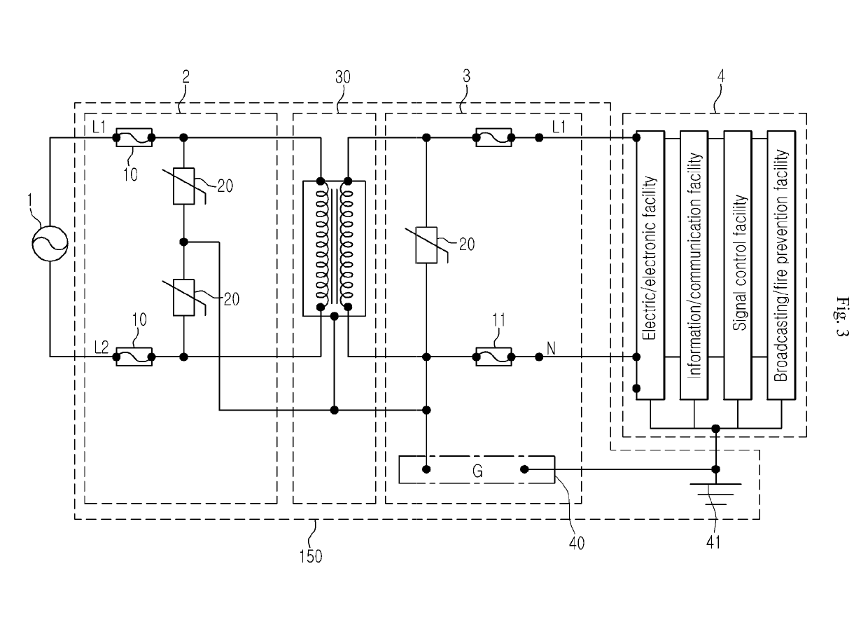

FIG. 3 is a circuit diagram showing a configuration of a lightning protection apparatus, which is applied to a single-phase two-line power supply system, according to a first embodiment of the present invention. Referring to FIG. 3, electric power of the power source 1 is supplied to a primary side of the double winding transformer 30 via two first switches 10 in the input part surge protection circuit 2 through a single-phase two line connection. The two first switches 10 are connected to two electrostatic devices 20 for an input part surge protection circuit, and an intermediate point of the two electrostatic devices 20 for the input part surge protection circuit are connected to the neutral line of the double winding transformer 30. A secondary side of the double winding transformer 30 is connected to the load facilities 4 such as electric/electronic facilities, information communication facilities, signal control facilities, and broadcasting/fire prevention facilities through two second switches 11 in the output part surge protection circuit 3. The electrostatic devices 20 for an output part surge protection circuit are also connected to a neutral line of the double winding transformer 30. Since the first switches 10 and the second switches 11 can electrically separate a power supply line from the load facilities, they can ultimately protect the load facilities even in the event where operations of the input part and output part surge protection circuits 2, 3 are imperfect. Meanwhile, an intermediate point of the two electrostatic devices 20 for the input part surge protection circuit, the neutral line of the double winding transformer 30, the electrostatic devices of the output part surge protection circuit 3, and a ground 41 of the load facilities 4 are connected to one ground terminal 40, whereby they can have the same electric potential. Thus, the load facilities 4 can be prevented from being damaged or malfunctioning due to difference between electric potentials even in the event where residual abnormal voltage is generated. The electrostatic devices 20 in the input part and output part surge protection circuit 2, 3 are not specifically limited, but include electrostatic devices such as gas discharge tubes (GDTs), MOVs, Zener diodes, SCR, varistors, TRIACs, arrestors, etc.

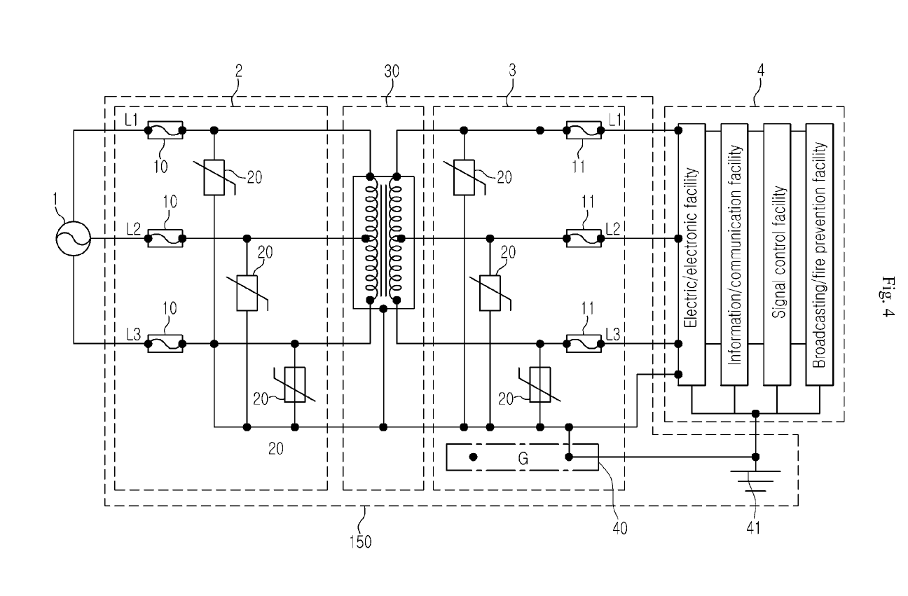

FIG. 4 is a circuit diagram showing a configuration of a lightning protection apparatus, which is applied to a three-phase three-line power supply system, according to a second embodiment of the present invention. Referring to FIG. 4, a three phase three line power supply system is applied although there is significant difference between FIG. 3 and FIG. 4, and first switches 10 for three first switches for an input part surge protection circuit 2 are connected to a power source 1 and ends of electrostatic devices 20 are connected to the first switches 10, respectively, and are connected to a primary side of a double winding transformer 30. Opposite ends of the electrostatic devices 20 connected to the first switches 10 are connected to a ground terminal 40 together with a neutral line of the double winding transformer 30 such that they have the same electric potential. In addition, the ground terminal 40 is connected to opposite ends of the electrostatic devices 20, which are connected to the three second switches 11 for an output part surge protection circuit 3 and the ground 41 of the load facilities 4 such that the elements connected to the ground terminal 40 have the same electric potential. According to this system, the three phase three line power supply system can be effectively protected from lightning, as described above.

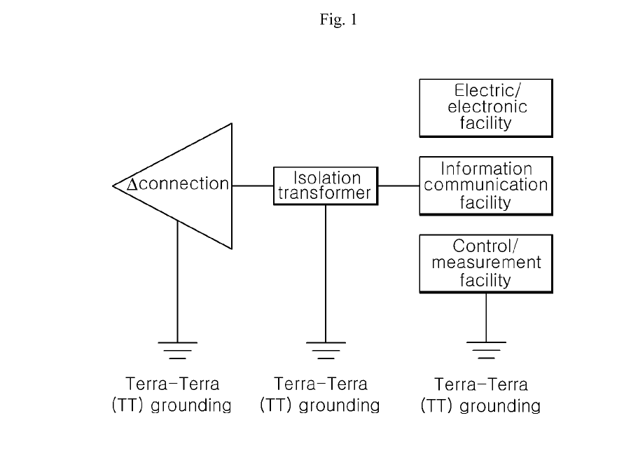

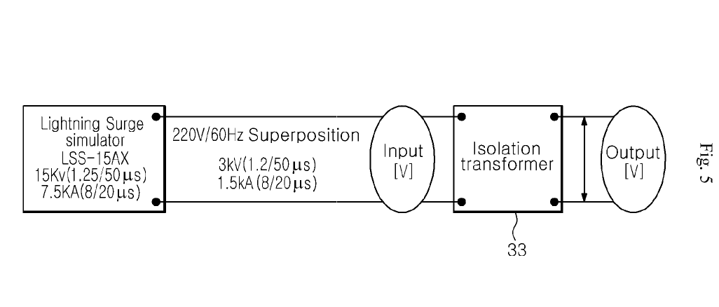

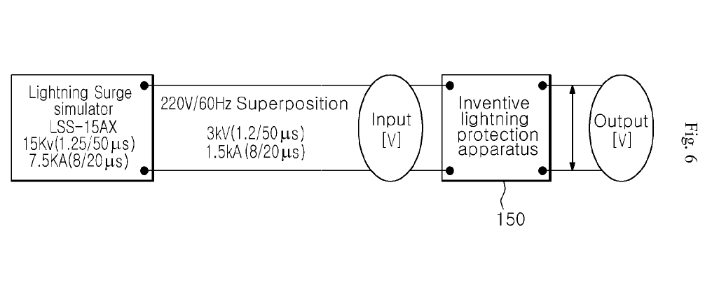

FIG. 5 is a schematic diagram of a facility for testing lightning surge voltage interruption performance of the isolation transformer 33 of FIG. 1. FIG. 6 is a schematic diagram of a facility for testing lightning surge voltage interruption performance of the lightning protection apparatus 150 of FIG. 2. Referring to FIGS. 5 and 6, upon application of a primary input voltage of 3 kV, a secondary output voltage was measured using a lightning surge simulator (LSS) (Model: LSS-15AX), which generates an open-circuit 1.2/50 μs is voltage waveform and a short-circuit 8/20 μs is current waveform.

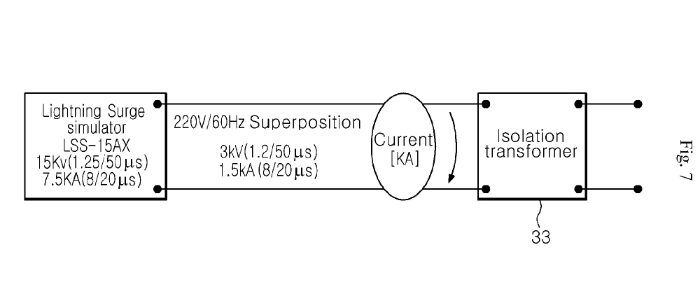

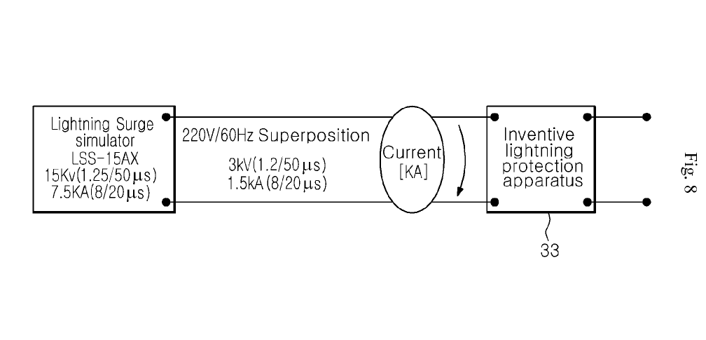

FIG. 7 is a schematic diagram of a facility for testing lightning surge current discharge performance of the isolation transformer of FIG. 1. FIG. 8 is a schematic diagram of a facility for testing lightning surge current discharge performance of the lightning protection apparatus of FIG. 2. Referring to FIGS. 7 and 5B, a discharge current was measured using the LSS-15AX LSS tester upon application of a test current of 1.5 kA. A result is shown in FIG. 6.

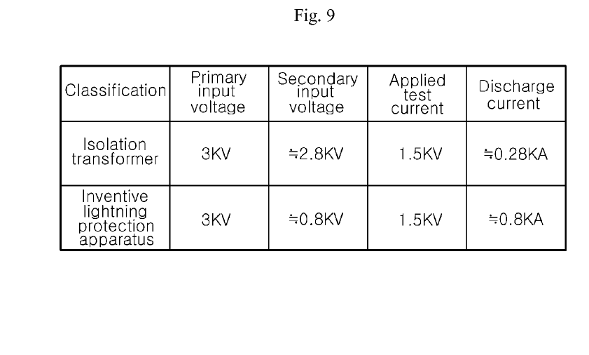

FIG. 9 is a table depicting test results of the facilities of FIGS. 5 to 8. Referring to FIG. 6, the lightning protection apparatus of the present invention lowers a secondary output voltage (2.8 kV→0.8 kV) and increases a discharge current (0.28 kA→0.8 kA), as compared with the case of using an isolation transformer in the related art, which shows that the lightning protection apparatus according to the preset invention is effective.

1. A lightning protection apparatus using a TN-C common ground disposed between a power supply and load facilities and connected in series thereto to protect the power supply and the load facilities from lightning, comprising:
an input part surge protection circuit connected to the power supply;
an output part surge protection circuit connected to the load facilities;
a double winding transformer having a primary part and a secondary part connected to the input part surge protection circuit and the output part surge protection circuit, respectively; and
a common grounding unit connected to the input part surge protection circuit, the double winding transformer, the output part surge protection circuit, and the load facilities such that all electric potentials applied thereto are the same as a reference electric potential.

2. The lightning protection apparatus using a TN-C common ground according to claim 1, wherein the double winding transformer comprises a Y-connection having a neutral line, each of the input part surge protection circuit and the output part surge protection circuit comprises an electrostatic device, and the neutral line and the electrostatic devices are connected to the common grounding unit.

3. The lightning protection apparatus using a TN-C common ground according to claim 2, wherein the input part surge protection circuit comprises a first switch for interrupting a connection with the power supply, and the output part surge protection circuit comprises a second switch for interrupting connections with the load facilities.

4. The lightning protection apparatus using a TN-C common ground according to claim 3, wherein the electrostatic device of the input part surge protection circuit is connected to the power supply through the first switch, and the electrostatic device of the output part surge protection circuit is connected to the load facilities through the second switch.

5. The lightning protection apparatus using a TN-C common ground according to claim 1, wherein the power supply comprises a power source and a delta connection power source circuit.
